(19) United States
(12) Patent Application Publication
(10) Pub. No.: US 2007/0079329 A1
(43) Pub. Date: Apr. 5, 2007

(54) Broadcast receiving apparatus and broadcast receiving method

(75) Inventor: Mitsutoshi Aoyagi, Kawagoe-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/528,570

(22) Filed: Sep. 28, 2006

(30) Foreign Application Priority Data
Sep. 30, 2005 (JP) 2005-288381

(51) Int. Cl. H04N 5/445

(52) U.S. Cl. 725/37

(57) ABSTRACT

A broadcast receiving apparatus has acquiring unit acquires video information via a network, tuner unit receives and demodulates a broadcast signal and outputs video information, selecting unit receives the video information and outputs the video information of one of them, processing unit processes video information and thereby outputs reproduction signal of the video information, operating unit outputs operation signal, and control unit, upon receipt of a channel change signal from the operating unit while the processing unit is reproducing video information via the network, outputs confirmation screen signal to confirm whether to change a channel or not, and upon receipt of an instruction signal to change a channel with respect to the confirmation screen via the operating unit, controls the selecting unit so as to select and output the video information from the tuner unit.

### CROSS-REFERENCE TO RELATED APPLICATIONS

This application is based upon and claims the benefit of priority from Japanese Patent Application No. 2005-288381, filed Sep. 30, 2005, the entire contents of which are incorporated herein by reference.

### BACKGROUND

1. Field

One embodiment of the invention relates to a broadcast receiving apparatus, and more specifically, to a broadcast receiving apparatus such as a television apparatus for receiving broadband broadcast via the Internet and a broadcasting receiving method.

2. Description of the Related Art

Recently, along with the spread of the Internet, television receivers that reproduce video information acquired via the Internet have been developed and spread even in the field of common television receivers.

Patent Document 1 (Jpn. Pat. Appln. KOKAI Publication No. 2005-130087) discloses a multimedia apparatus that acquires a video signal from a site on the Internet and reproduces the acquired signal.

However, in this prior art, nothing is disclosed on the use together with a signal from another medium, for example, a tuner of TV broadcast. In general, it is considered that when, for example, a TV broadcast channel button on a remote controller is pressed, a channel corresponding to the channel button number is selected, so that a medium being currently viewed (in this case, broadband broadcast) is discontinued.

However, it is not necessarily appropriate that once the TV broadcast channel button on the remote controller is pressed, viewing of broadband broadcast is discontinued immediately and TV broadcast is switched on. This is because when, in a current broadband broadcast viewing style, a user discontinues the broadband broadcast viewed currently once, and then wants to view the rest of the program, the user fails to view the reset of the same program in a moment, and consequently, the user is subject to complicated procedures including selecting the menu several times and fast-forwarding the scenes already viewed, which has been a problem in the prior art. Further, in the case of a pay-per-view broadcast program, broadband broadcast is discontinued abruptly in a charged state when the user touches an operation button on the remote controller by mistake. As-a result, when the user goes back to the program through complicated procedures, charging is newly made on the program, which has been another problem with the prior art.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a broadcast receiving apparatus according to one embodiment of the present invention;

FIG. 2 is an external view showing an example of a remote controller of the broadcast receiving apparatus according to the embodiment of the present invention;

FIG. 3 is an explanatory view showing an example of an operation screen to prompt a user selection in the broadcast receiving apparatus according to the embodiment of the present invention;

FIG. 4 is an explanatory view showing an example of an operation screen to prompt a user selection in the broadcast receiving apparatus according to the embodiment of the present invention;

FIG. 5 is an explanatory view showing an example of an operation screen to prompt a user selection in the broadcast receiving apparatus according to the embodiment of the present invention;

FIG. 6 is an explanatory view showing an example of an operation screen to prompt a user selection in the broadcast receiving apparatus according to the embodiment of the present invention;

FIG. 7 is an explanatory view showing an example of an operation screen to prompt a user selection in the broadcast receiving apparatus according to the embodiment of the present invention;

FIG. 8 is a flowchart showing an example of a switching confirmation process in the broadcast receiving apparatus according to the embodiment of the present invention;

FIG. 9 is a flowchart showing another example of the switching confirmation process in the broadcast receiving apparatus according to the embodiment of the present invention;

FIG. 10 is a flowchart showing another example of the switching confirmation process in the broadcast receiving apparatus according to the embodiment of the present invention; and

FIG. 11 is a flowchart showing still another example of the switching confirmation process in the broadcast receiving apparatus according to the embodiment of the present invention.

### DETAILED DESCRIPTION

Various embodiments according to the invention will be described hereinafter with reference to the accompanying drawings. In general, according to one preferred embodiment of the present invention, there are provided a broadcast receiving apparatus and a broadcasting receiving method for making it possible to appropriately perform an operation of viewing broadband broadcast together with an operation of viewing another media.

According to one embodiment of the invention, there is provided a broadcast receiving apparatus comprising: an acquiring unit which acquires video information via a network; a tuner unit which receives and demodulates a broadcast signal and outputs video information; a selecting unit which receives the video information from the acquiring unit or the tuner unit, and outputs the video information of one of them; a processing unit which processes the video information supplied from the selecting unit and thereby outputs a reproduction signal of the video information; an operating unit which outputs an operation signal in response to operation; and a control unit which, upon receipt of a channel change signal from the operating unit while the processing unit is reproducing video information via the network, outputs a signal for a confirmation screen to confirm whether to change a channel or not, and upon receipt of an instruction signal to change a channel with respect to the confirmation screen via the operating unit, controls the selecting unit so as to select and output the video information from the tuner unit.

There is provided a broadcast receiving apparatus that does not discontinue broadband broadcast at once even with operations such as switching a channel and switching an input, but switches to the channel of a TV tuner through a user's re-confirmation operation.

Hereinafter, embodiments of the present invention will be described in more details with reference to the accompanying drawings.

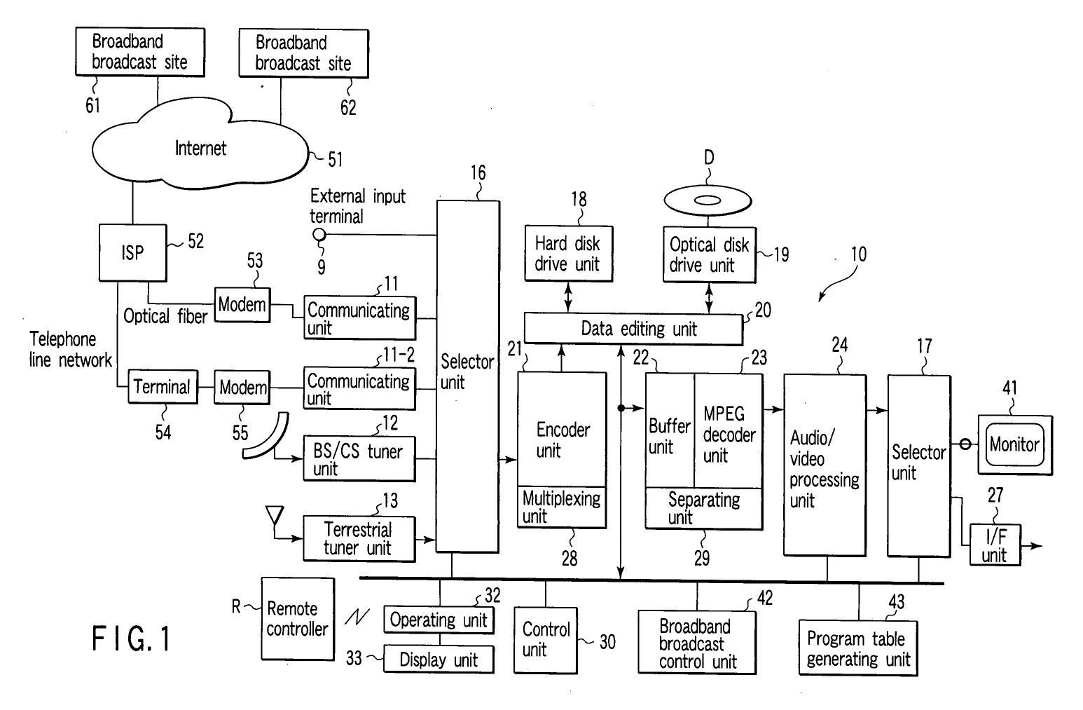

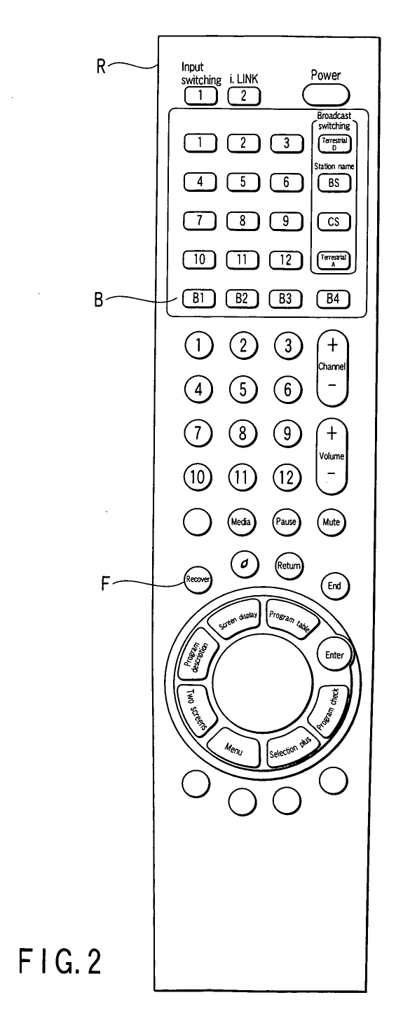

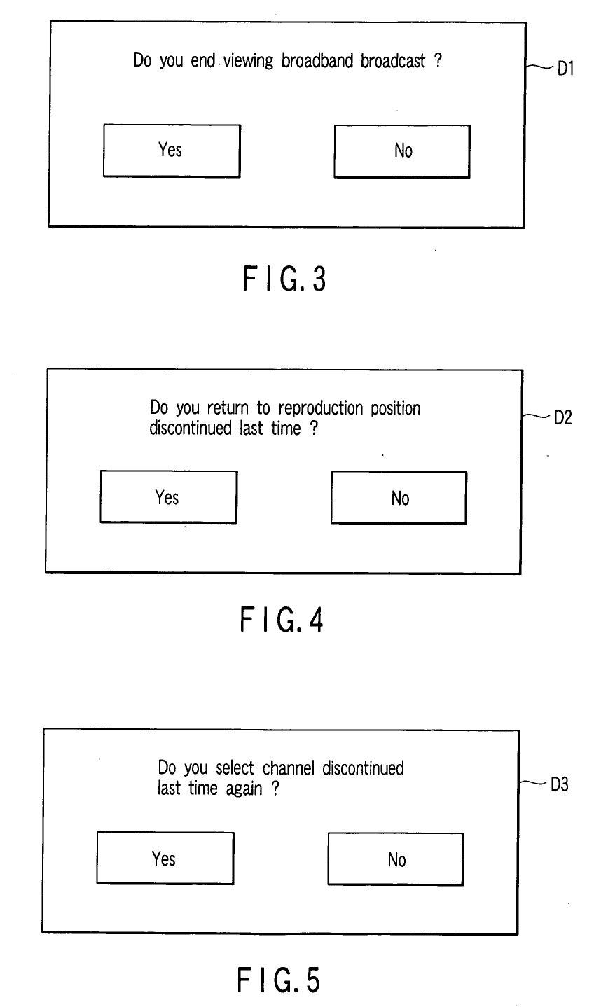

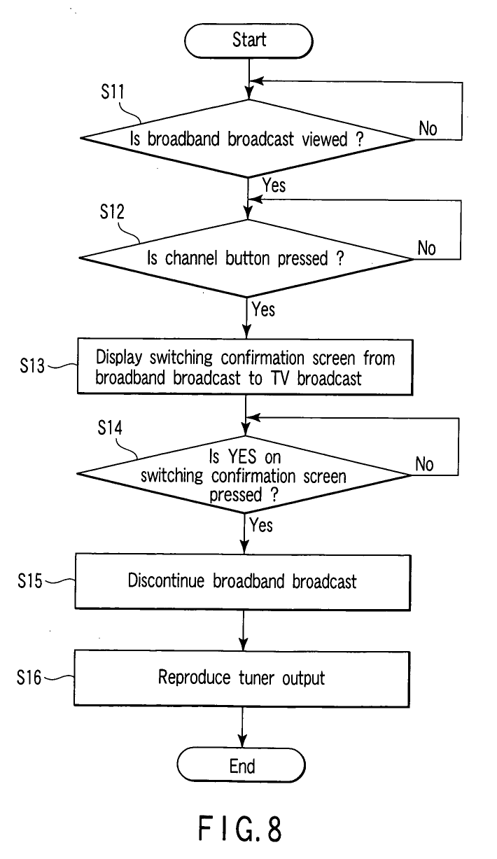

Here, FIG. 1 is a block diagram showing an example of a configuration of a broadcast receiving apparatus according to one embodiment of the present invention. FIG. 2 is an external view showing an example of a remote controller of the broadcast receiving apparatus according to the embodiment of the present invention. FIG. 3 is an explanatory view showing an example of an operation screen to prompt a user selection in the broadcast receiving apparatus according to the embodiment of the present invention. FIGS. 4 to 7 are explanatory views each showing an example of an operation screen to prompt a user selection in the broadcast receiving apparatus according to the embodiment of the present invention. FIGS. 8 to 11 are flow charts each showing an example of a switching confirmation process in the broadcast receiving apparatus according to the embodiment of the present invention.

Broadcast Receiving Apparatus According to One Embodiment of the Invention

An example of the broadcast receiving apparatus according to the embodiment of the invention will be explained with reference to the drawings hereinafter. A recording/reproducing function for a hard disk and an optical disk is loaded on the broadcast receiving apparatus. However, the recording/reproducing function is not necessarily required, so long as the apparatus is a broadcast receiving apparatus having at least a broadband broadcast receiving function and a TV broadcast receiving function (or an external video signal inputting function).

(Configuration)

First, FIG. 1 is a block diagram showing an example of the configuration of the broadcast receiving apparatus according to the embodiment of the present invention. The broadcast receiving apparatus 10 in FIG. 1 has two kinds of disk drive units, i.e., an optical disk drive unit 19 and a hard disk drive unit 18. The optical disk drive unit 19 rotates and drives an optical disk D as a first medium as an information recording medium for configuring video files, and reads and writes information from and into the disk. The hard disk drive unit 18 drives a hard disk as a second medium. A control unit 30 is connected to respective units via a data but so as to control the entire operation of the apparatus.

Further, the broadcast receiving apparatus 10 in FIG. 1 has an encoder unit 21 that configures a recording side, an MPEG decoder unit 23 that configures a replay side, and the control unit 30 that controls the operation of the apparatus main body as its main components. The broadcast receiving apparatus 10 has a selector 16 at the input side and a selector 17 at the output side.

To the selector 16 at the input side, an external input terminal 9 that takes in a video signal and the like from the outside, a communicating unit 11 such as Ethernet (registered trademark) connected to a modem 53 via an optical fiber, a terminal 54 via a telephone line network, and a communicating unit 11-2 such as Ethernet (registered trademark) connected to a modem 55 are connected by way of example. Herein, the modem 53 is connected to an internet service provider 52 via the optical fiber and the terminal 54 is also connected to the internet service provider 52 via the optical fiber, and the internet service provider 52 is connected to the Internet.

Furthermore, a so-called satellite broadcasting (BS/CS) tuner unit 12, and a so-called terrestrial tuner unit 13 are connected to the selector 16 at the input side, and output signals to the encoder unit 21. Further, a satellite antenna is connected to the BS/CS tuner unit 12, while a terrestrial antenna is connected to the terrestrial tuner unit 13. The broadcast receiving apparatus 10 has the encoder unit 21, a data editing unit 20 that receives the output of the encoder unit 21 and performs desired data processing such as data editing, and the hard disk drive unit 18 and the optical disk drive unit 19 that are connected to the data editing unit 20. The broadcast receiving apparatus 10 also has the MPEG decoder unit 23 that receives signals from the hard disk drive unit 18 and the optical disk drive unit 19 and decodes the signals, the encoder unit 21, a buffer unit 22, the MPEG decoder unit 23, a multiplexing unit 28, a separating unit 29, the control unit 30, a broadband broadcast control unit 42, and a program table generating unit 43 that generates a timer recording list and program table images. These units are connected to the control unit 30 via the data bus. Further, the output of the selector unit 17 is supplied to a monitor 41, and supplied to an external device via an interface unit 27 that performs communication with the external device.

Furthermore, the broadcast receiving apparatus 10 has an operating unit 32 that is connected to the control unit 30 via the data bus, the operating unit 32 receiving operations of a user and operations of a remote controller R. Herein, the remote controller R can perform substantially the same operations as those of the operating unit 32 provided in the main body of the broadcast receiving apparatus 10. In addition, the remote controller R can perform a recording/reproduction instruction for the hard disk drive unit 18 and the optical disk drive unit 19, an editing instruction, operations of tuners, and various settings including setting of timer recording. When broadband selection switches B are selected, the apparatus is connected to sites of the set addresses.

(Operation)

—Basic Operation

For example, when the broadband selection switches B on the remote controller R are selected in the broadcast receiving apparatus 10 of the configuration described above, the apparatus accesses to sites 61 and 62 of set addresses under the control of the control unit 30 and the broadband broadcast control unit 42 via the communicating unit 11, the modem 53, the optical fiber and an ISP 52, or via the communicating unit 11-2, the modem 54, the telephone line network and the ISP 52, through the Internet. Then, the apparatus downloads video information as content information of broadband broadcast from the broadband broadcast sites 61 and 62, etc. Meanwhile, it is preferable that the communicating units 11 and 11-2 are controlled by the broadband broadcast control unit 42 to selectively use an optical fiber route and a telephone line network route according to the kinds of the broadband broadcast sites 61 and the like. However, in a configuration with one of them, viewing broadband broadcast is available in the same manner.

Downloaded video information is supplied via the selector unit 16, decoded by the MPEG decoder unit 23, and supplied to an audio/video processing unit 24 to be made into a video/audio signal that can be displayed on a monitor 41, and the video/audio signal is supplied to the monitor 41 and an I/F unit 27 and displayed thereon.

Further, in response to the operation at the operating unit 32, the BS/CS tuner unit 12 and the terrestrial tuner unit 13 receive and demodulate a broadcast signal desired by the user under the control of the control unit 30. Then, the demodulated signal is supplied via the selector unit 16 to the MPEG decoder unit 23 or the audio/video processing unit 24. Consequently, the demodulated signal is output from the audio/video processing unit 24 as a video/audio signal that can be displayed on the monitor 41, and the output signal is supplied to the monitor 41 and the I/F portion 27 and displayed thereon.

Now, the outline of reproducing process and recording process in the broadcast receiving apparatus 10 of the configuration described above will be explained with an optical disk as an example. Under the control of the control unit 30, laser beam is radiated to the optical disk D that is turned at a predetermined speed, the reflected light thereof is detected by an optical pickup, and a detection signal based thereon is output. On the basis of this detection signal, an RF signal is generated, and reproduction process is performed after data reading process.

The recording process for the optical disk is performed as follows. That is, under the control of the control unit 30, data supplied via, for example, an input unit (not shown) and the selector unit 16 is supplied to the encoder unit 21, and encoded to be output. In response to the encoded output and the output of the control unit 30, a drive current of a laser driver is supplied to the optical pickup, and radiated to a memory area of the optical disk D, whereby the recording process is carried out.

<Operation at Receiving Broadband Broadcast>

Next, respective embodiments at the time of receiving broadband broadcast in the broadcast receiving apparatus according to the embodiment of the present invention will be explained in details with reference to the flowchart. Since the following flowchart can be made of circuit blocks, each step of the flowchart can be defined as a block.

(Channel Switching Process)

First, a process in the broadcast receiving apparatus 10 according to the embodiment of the invention will be explained with reference to the flowchart in FIG. 8. In the process, when a channel button (irrespective of for example, terrestrial analog, terrestrial digital, BS analog, or BS digital) of the remote controller R is pressed while broadband broadcast is viewed by use of the communicating units 11 and 11-2, a switching confirmation screen is displayed and confirmation is made, and then, a desired channel is switched on. Since the following flowchart can be made of circuit blocks, each step of the flowchart can be defined as a block.

First, under the control of the control unit 30 and the broadband broadcast control unit 42, access is made to the broadband broadcast site 61 or the like on the Internet to download video information in response to the operation on the remote controller R by the user, and it is determined whether or not video and audio of broadband broadcast are being reproduced (step S11). In this state, the user is viewing broadband broadcast of the broadband broadcast site 61 or the like, and if the user intentionally or mistakenly presses the channel button of the remote controller R (step S11), this operation signal is supplied to the control unit 30 or the broadband broadcast control unit 42 (step S12).

Herein, under the control of the control unit 30 and the broadband broadcast control unit 42, a switching confirmation screen D1 as shown in FIG. 3 is generated by the broadband broadcast control unit 42 or the like, and displayed on the monitor 41 (step S13). In this case, when YES on the switching confirmation screen D1 is pressed by the operation on the remote controller R or the like by the user (step S14), broadband broadcast is discontinued (step S15). Note that various modes for discontinuing broadband broadcast are proposed, and are described later.

In response to given channel information, the output of a broadcast signal selected by the tuner 12 or 13 is supplied via the selector 16 to the MPEG decoder unit 23 or directly to the audio/video processing unit 24, so that the video/audio signal is reproduced (step S16).

If NO is pressed in step S14, or the time is out without any operation on the switching confirmation screen D1, the screen returns to the current broadband broadcast screen.

In this manner, even when the channel button of the remote controller R is pressed or the like, and the channel change signal is supplied, the broadband broadcast is not discontinued at once, but the inquiry is made on the switching confirmation screen D1. Consequently, it is possible to avoid complicated operations after misoperation on the channel button by the user (including selecting the menu several times, fast-forwarding reviewed scenes, and the like), and provide a stable operating environment.

(Channel Switching Process and Recovery Process)

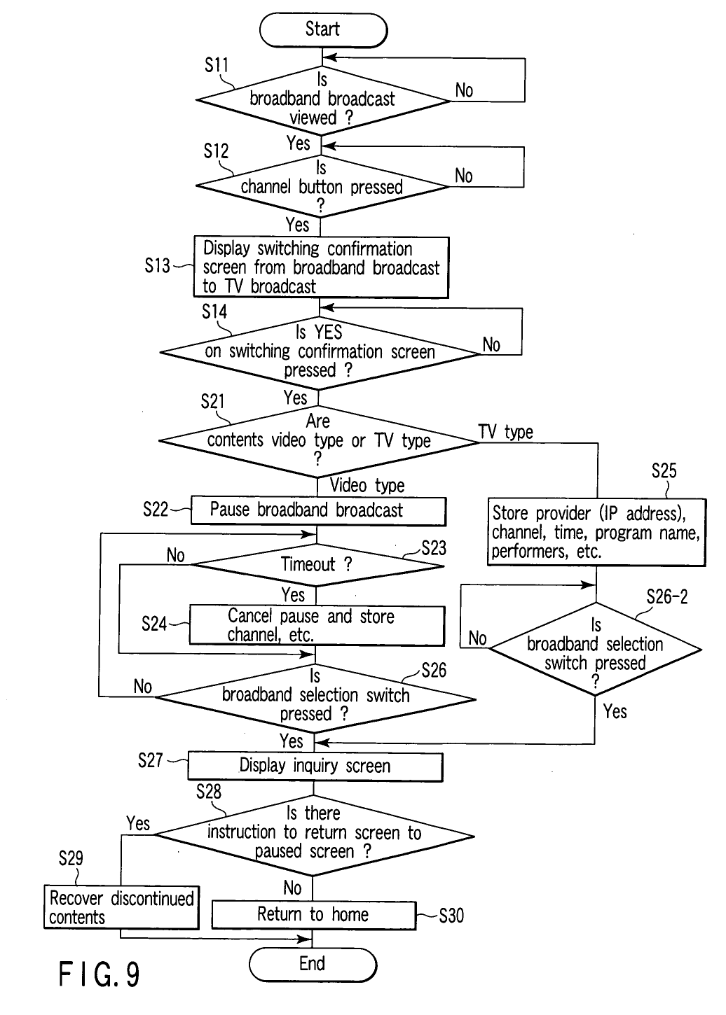

Next, a channel switching process including a subsequent recovery process for broadband broadcast will be explained with reference to the flowchart in FIG. 9. Since the following flowchart can be made of circuit blocks, each step of the flowchart can be defined as a block.

First, under the control of the control unit 30 and the broadband broadcast control unit 42, access is made to the broadband broadcast site 61 or the like on the Internet to download video information in response to the operation on the remote controller R by the user, and it is determined whether or not vide and audio of broadband broadcast are being reproduced (step S11). In this state, the user is viewing broadband broadcast of the broadband broadcast site 61 or the like, and if the user intentionally or mistakenly presses the channel button of the remote controller R, this operation signal is supplied to the control unit 30 or the broadband broadcast control unit 42 (step S12).

Herein, under the control of the control unit 30 and the broadband broadcast control unit 42, a switching confirmation screen D1 as shown in FIG. 3 is generated by the broadband broadcast control unit 42 or the like, and displayed on the monitor 41 (step S13). In this case, when YES on the switching confirmation screen D1 is pressed by the operation on the remote controller R or the like by the user (step S14), the process goes to the switching process. That is, it is determined whether the contents of the broadband broadcast are those of video-on-demand type (accumulative type) using a video-on-demand function having a pause function, or those of TV type (sequential sending type) to provide contents in real time (or video-on-demand type without a pause function) (step S21).

In the case of the video-on-demand type (accumulative type), operations such as pause and fast forwarding are available in the same manner as video, digital versatile disk (DVD) and the like. For this reason, even if the user discontinues broadband broadcast and selects TV broadcast, the user can return to reproduction by canceling the paused state when the user switches to broadband broadcast next time by use of the pause function.

Accordingly, in the case where contents are of the video-on-demand type using the video-on-demand function having the pause function, broadband broadcast is paused (step S22). Thereafter, at timeout of pause available time (step S23), pause is cancelled to store provider (IP address), channel, time, program name, performers and the like (step S24).

It is checked whether or not timeout is made until timeout, and it is checked whether or not the broadband selection switch B of the remote control R or the like is pressed (step S26).

On the other hand, contents are of TV type (sequential sending type) (step S21), a pause cannot be made, so that provider (IP address), channel, time, program name, performers and the like are stored at once (step S25). At the same time, it is checked whether or not the broadband selection switch B of the remote control R or the like is pressed (step S26-2).

If the broadband selection switch B is pressed (steps S26, S26-2), an inquiry screen D2 as shown in FIG. 4 is displayed under the control of the broadband broadcast control unit 42 and the like, and it is asked whether to return the screen to the discontinued portion or not (step S27). In this case, if there is an instruction to return the screen to the paused screen (step S28), discontinued contents are recovered (step S29).

If time is not out in step S23, paused broadband broadcast is resumed, and reproduction from the paused position can be made at once. If time is out in step S23, on the other hand, access is made, under the control of the broadband broadcast control unit 42, to the broadband broadcast site 61 or the like via the communicating unit 11 or the like once again on the basis of the channel, time, program name, performers and the like stored in step S24, so that desired broadband broadcast is reproduced from the paused position (step S29). Herein, the stored time includes information of a time counter at the paused position (for what time reproduction has been made from the head). In the case of recovery after timeout, the video-on-demand program being viewed automatically is started from the head, and fast forwarding (jumping) is made to the position of the stored time counter to perform reproduction from the paused position.

When NO is pressed to the inquiry screen whether to return the screen to the paused position or time is out in step S28, the screen returns to the home screen of broadband broadcast (step S30). Herein, it is also preferable not to return to the home screen at once but to display the inquiry screen D3 in FIG. 5. If the answer to the inquiry screen D3 is YES, access is made to the broadband broadcast site 61 or the like via the communicating unit 11 or the like on the basis of the stored channel, and broadband broadcast of the same channel is reproduced. In this case, the broadband broadcast of the channel is reproduced not from the paused position but from the head. If the answer is NO, the screen returns to the home screen of broadband broadcast (step S30).

By such a method, the broadcast receiving apparatus 10 according to the invention performs switching after confirmation on the switching confirmation screen D1 if there is any channel operation or input switching while broadband broadcast is viewed, and thereafter reproduces broadband broadcast from the paused position according to the user's operation with respect to the switching confirmation screen.

Further, as a switch whose pressing is confirmed in step S26, there is the broadband selection switch B of the remote controller R. However, in addition thereto, it is preferable that a recovery switch F or the like is arranged on the remote controller R as shown in FIG. 2, and if it is detected that the recovery switch F is pressed after broadband broadcast is stopped, the process goes directly to step S29, whereby broadband broadcast is reproduced from the paused position. Further, it is preferable to provide a function such that when broadband broadcast is recovered from the paused position, reproduction is made by fast forwarding from the head of broadband broadcast, and when the reproduction button is pressed in the course, reproduction is started from the pressed position.

(Channel Switching Process in Consideration of Pay-per-view Broadcast)

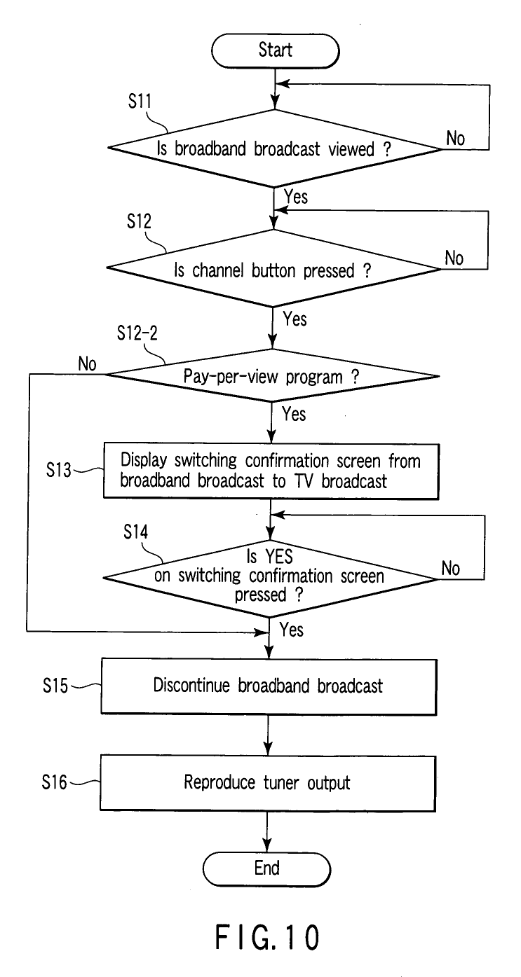

Next, a channel switching process in consideration of the case where broadband broadcast is pay-per-view broadcast will be explained with reference to the flowchart in FIG. 10. Explanations on portions basically same as those in the flowchart in FIG. 8 are omitted, and only different points are explained. Since the following flowchart can be made of circuit blocks, each step of the flowchart can be defined as a block.

When in step S12, while the user is viewing broadband broadcast of the broadband broadcast site 61 or the like under the control of the broadband broadcast control unit 42, the user intentionally or mistakenly presses the channel button of the remote controller R, and this operation signal is supplied to the control unit 30 or the broadband broadcast control unit 42, it is asked whether the broadband broadcast is pay-per-view broadcast or not (step S12-2).

When the broadband broadcast is not pay-per-view broadcast, the process goes directly to step S15 without displaying the switching confirmation screen D1 as shown in FIG. 3, and the broadband broadcast is discontinued (step S15). This is based on the thought that if the broadband broadcast is not pay-per-view broadcast, damage is small as compared with free broadcast and there is no problem even when the broadband broadcast is discontinued by mistake. As a consequence, it is possible to omit the switching confirmation screen D1 that becomes troublesome in changing channels.

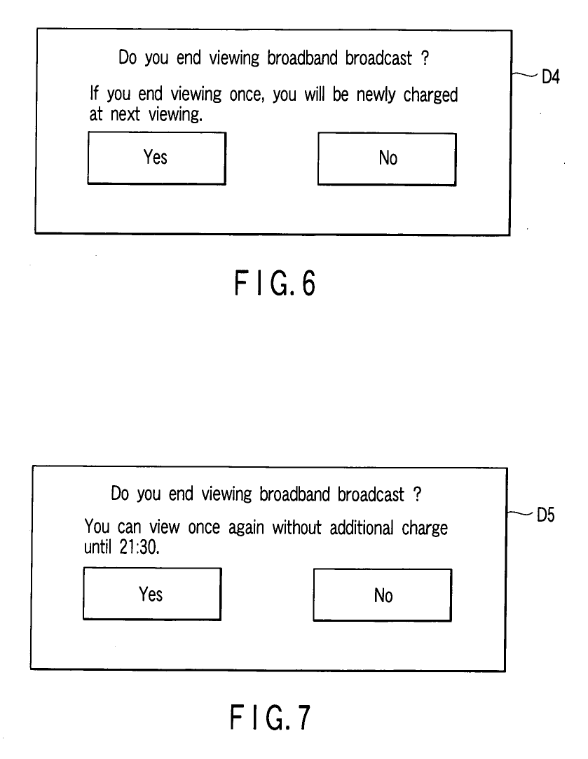

On the other hand, when the broadband broadcast is pay-per-view broadcast (step S12-2), the switching confirmation screen D1 in FIG. 3 is displayed. At this moment, it is preferable to, under the control of the broadband broadcast control unit 42, display a warning message to the user “If you end viewing once, you will be newly charged at next viewing” because the broadband broadcast is pay-per-view broadcast, as shown in the switching confirmation screen D4 in FIG. 6.

Even if the broadband broadcast is pay-per-view broadcast, there is not so large disadvantage to the user in directly changing channels in the case of monthly pay-per-view broadcast. For this reason, it is preferable to change channels after confirming the confirmation screen when there is a channel changing instruction only on charged broadcast for one hour or two hours or charged broadcast per content.

Furthermore, it is preferable to, under the control of the broadband broadcast control unit 42, display a message such as “You can view once again without additional charge until 21:30” so as to indicate the effective time of pay-per-view broadcast as shown in the switching confirmation screen D5 in FIG. 7, in consideration of broadcast time of pay-per-view broadcast and a current time.

(Channel Switching Process and Recovery Process in Consideration of Pay-per-view Broadcast)

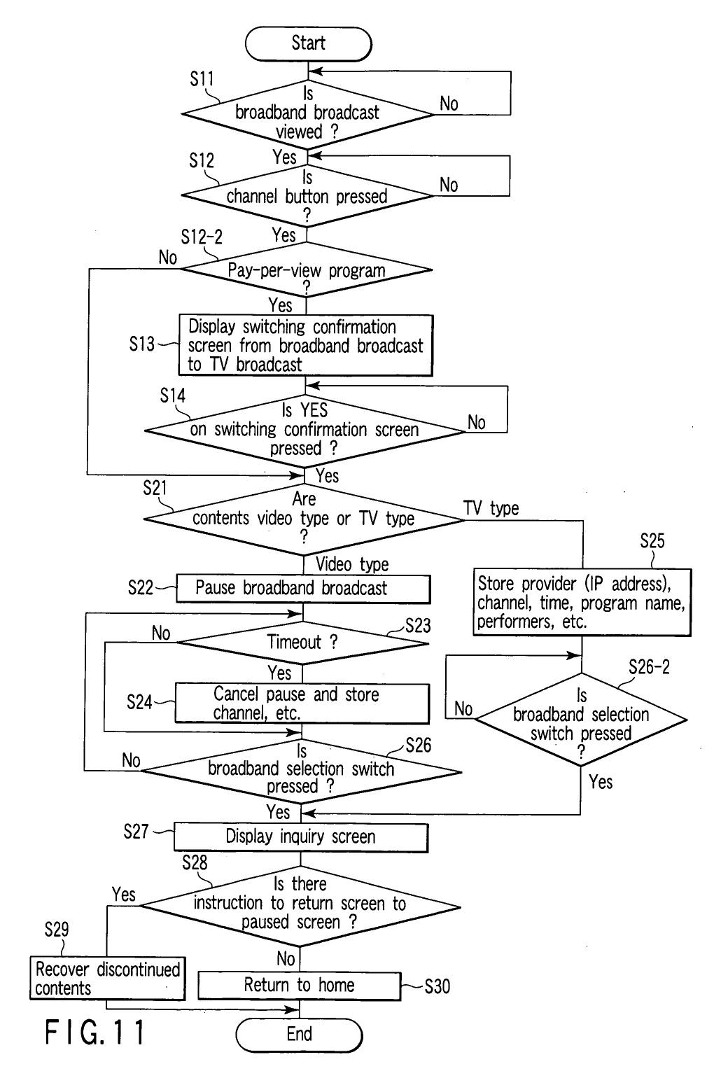

Further, a channel switching process and a recovery process in consideration of the case where broadband broadcast is pay-per-view broadcast will be explained with reference to the flowchart in FIG. 11. Explanations on portions basically same as those in the flowchart in FIG. 9 are omitted, and only different points are explained.

When in the step S12, while the user is viewing broadband broadcast of the broadband broadcast site 61 or the like under the control of the broadband broadcast control unit 42, the user intentionally or mistakenly presses the channel button of the remote controller R, and this operation signal is supplied to the control unit 30 or the broadband broadcast control unit 42, it is asked whether the broadband broadcast is pay-per-view broadcast or not (step S12-2).

When the broadband broadcast is not pay-per-view broadcast, the process goes directly to step S21 without displaying the switching confirmation screen D1 as shown in FIG. 3, and the type of contents is determined (step S21). This is based on the thought that if the broadband broadcast is not pay-per-view broadcast, damage is small as compared with free broadcast and there is no problem even when the broadband broadcast is discontinued by mistake. For this reason, it is possible to omit the switching confirmation screen D1 that becomes troublesome in changing channels.

On the other hand, when the broadband broadcast is pay-per-view broadcast (step S12-2), the switching confirmation screen D1 in FIG. 3 is displayed. At this moment, it is preferable to, under the control of the broadband broadcast control unit 42, display a warning message to the user “If you end viewing once, you will be newly charged at next viewing” because the broadband broadcast is pay-per-view broadcast, as shown in the switching confirmation screen D4 in FIG. 6.

It is also preferable to, under the control of the broadband broadcast control unit 42, display a message such as “You can view once again without additional charge until 21:30” so as to indicate the effective time of pay-per-view broadcast as shown in the switching confirmation screen D5 in FIG. 7, in consideration of broadcast time of pay-per-view broadcast and a current time.

Moreover, in the embodiment shown by the flowcharts in FIGS. 8 to 11, the switching operation to change channels of the tuner units 12 and 13. However, in the embodiment of the present invention, the switching confirmation screen D1 and the like are displayed for confirmation, not only in changing channels, but also in the switching operation to the video signal supplied from the external input terminal 9 in FIG. 1. Consequently, for example, even if the external input button of the remote controller or the like is pressed suddenly while broadband broadcast as pay-per-view broadcast is being viewed, the switching confirmation screen D1 or the like is displayed, and switching is made only when there is an operation by the user in response thereto. Accordingly, it is possible to avoid a complicated recover operation or a nonconformity of wasting charging of pay-per-view broadcast.

Those skilled in the art can achieve the present invention through the various embodiments described above, and those skilled in the art also can image various modifications of these embodiments easily, so that they can apply the present invention to a variety of embodiments even if they are lack of inventive ability. Therefore, the present invention covers a wide range not inconsistent with the disclosed principles and novel features, and is not restricted to the above-described embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
an acquiring unit which acquires video information via a network;
a tuner unit which receives and demodulates a broadcast signal and outputs video information;
a selecting unit which receives the video information from the acquiring unit or the tuner unit, and outputs the video information of one of them;
a processing unit which processes the video information supplied from the selecting unit and thereby outputs a reproduction signal of the video information;
an operating unit which outputs an operation signal in response to operation; and
a control unit which, upon receipt of a channel change signal from the operating unit while the processing unit is reproducing video information via the network, outputs a signal for a confirmation screen to confirm whether to change a channel or not, and upon receipt of an instruction signal to change a channel with respect to the confirmation screen via the operating unit, controls the selecting unit so as to select and output the video information from the tuner unit.

2. A broadcast receiving apparatus according to claim 1, wherein the control unit controls the video information so as to: upon receipt of the instruction signal to change the channel via the operating unit, determine whether or not the video information via the network is pausable; pause the video information when it is pausable; discontinue reproduction of the video information and store respective items of communication information into a memory area when it is not pausable; and upon receipt of a reproduction instruction again, restart reproduction of the paused video information or perform reproduction from a paused screen on the basis of the stored communication information.

3. A broadcast receiving apparatus according to claim 1, wherein the control unit controls the video information so as to: upon receipt of the instruction signal to change the channel via the operating unit, discontinue reproduction of the video information and store respective items of communication information into a memory area; and upon receipt of a reproduction instruction again, perform reproduction from a paused screen on the basis of the stored communication information.

4. A broadcast receiving apparatus according to claim 1, wherein, upon receipt of the channel change signal when it is determined that the video information via the network is not pay-per-view broadcast, the control unit selects and outputs the video information from the tuner unit by the selecting unit without waiting for the instruction signal in response to the confirmation screen.

5. A broadcast receiving apparatus according to claim 1, wherein the control unit determines whether the video information acquired by the acquiring unit is accumulative type video information or sequential sending type video information, and when it is the accumulative type video information, discontinues reproduction of the video information and stores respective items of communication information into a memory area upon receipt of the instruction signal to change the channel via the operating unit, and upon receipt of a reproduction instruction again, performs reproduction from a paused screen on the basis of the stored communication information.

6. A broadcast receiving apparatus according to claim 1, wherein the acquiring unit is connected to a plurality of communicating units to which plural modems via plural networks for connection to internet service providers are connected.

7. A broadcast receiving apparatus according to claim 1, wherein, when it is determined that the video information via the network is pay-per-view broadcast, the control unit displays a message to the effect that viewing again will be newly charged after changing the channel in the confirmation screen.

8. A broadcast receiving apparatus according to claim 1, wherein, when it is determined that the video information via the network is pay-per-view broadcast, the control unit displays time until which viewing is available in a current charge range, in consideration of an effective time of the pay-per-view broadcast and a current time.

9. A broadcast receiving apparatus comprising:
an acquiring unit which acquires video information via a network;
an input unit which takes in video information from outside;
a selecting unit which receives the video information from the acquiring unit or the input unit, and outputs the video information of one of them;
a processing unit which processes the video information supplied from the selecting unit and outputs a reproduction signal of the video information;
an operating unit which outputs an operation signal in response to operation; and
a control unit which, upon receipt of an input switch signal from the operating unit while the processing unit is reproducing video information via the network, outputs a signal for a confirmation screen to confirm whether to change an input or not, and upon receipt of an instruction signal to change an input with respect to the confirmation screen via the operating unit, controls the selecting unit so as to select and output the video information from the input unit.

10. A broadcasting receiving method for use in a broadcast receiving apparatus comprising: an acquiring unit which acquires video information via a network; a tuner unit which receives and demodulates a broadcast signal and outputs video information; a selecting unit which receives the video information from the acquiring unit or the tuner unit, and outputs the video information of one of them; a processing unit which processes the video information supplied from the selecting unit and thereby outputs a reproduction signal of the video information; and an operating unit which outputs an operation signal in response to operation, the method comprising:
upon receipt of a channel change signal from the operating unit while the processing unit is reproducing video information via the network, outputting a signal for a confirmation screen to confirm whether to change a channel or not, and upon receipt of an instruction signal to change a channel with respect to the confirmation screen via the operating unit, controlling the selecting unit so as to select and output the video information from the tuner unit.

11. A broadcasting receiving method according to claim 10, further comprising:
controlling the video information so as to: upon receipt of the instruction signal to change the channel via the operating unit, determining whether or not the video information via the network is pausable; pause the video information if it is pausable; discontinue reproduction of the video information and store respective item of communication information into a memory area when it cannot be paused; and upon receipt of a reproduction instruction again, restart reproduction of the paused video information or perform reproduction from a paused screen on the basis of the stored communication information.

12. A broadcasting receiving method according to claim 10, further comprising:
controlling the video information so as to: upon receipt of the instruction signal to change the channel via the operating unit, discontinue reproduction of the video information and store respective items of communication information into a memory area; and upon receipt of a reproduction instruction again, perform reproduction from a paused screen on the basis of the stored communication information.

13. A broadcasting receiving method according to claim 10, further comprising:
upon receipt of the channel change signal when it is determined that the video information via the network is not pay-per-view broadcast, selecting and outputting the video information from the tuner unit by the selecting unit without waiting for the instruction signal in response to the confirmation screen.

14. A broadcasting receiving method according to claim 10, further comprising:
determining whether the video information acquired by the acquiring unit is accumulative type video information or sequential sending type video information; when it is the accumulative type video information, discontinuing reproduction of the video information and storing respective items of communication information into a memory area upon receipt of the instruction signal to change the channel via the operating unit; and upon receipt of a reproduction instruction again, performing reproduction from a paused screen on the basis of the stored communication information.

15. A broadcasting receiving method according to claim 10, wherein the broadcast receiving apparatus uses a plurality of communicating units to which plural modems via plural networks for connection to internet service providers are connected.

16. A broadcasting receiving method according to claim 10, further comprising:
when it is determined that the video information via the network is pay-per-view broadcast, displaying a message to the effect that viewing again will be newly charged after changing the channel in the confirmation screen.

17. A broadcasting receiving method according to claim 10, further comprising:
when it is determined that the video information via the network is pay-per-view broadcast, displaying time until which viewing is available in a current charge range, in consideration of an effective time of the pay-per-view broadcast and a current time.
